(19) United States
(12) Patent Application Publication
(10) Pub. No.: US 2013/0160944 A1
(43) Pub. Date: Jun. 27, 2013

(54) USE OF 2K CARTRIDGE ADHESIVES AS A LAMINATING ADHESIVE

(71) Applicant: Henkel AG & Co. KGaA, Duesseldorf (DE)

(72) Inventor: Michael Gierlings, Hilden (DE)

(73) Assignee: Henkel AG & Co. KGaA, Duesseldorf (DE)

(21) Appl. No.: 13/770,328

(22) Filed: Feb. 19, 2013

Related U.S. Application Data
(63) Continuation of application No. PCT/EP2011/060879, filed on Jun. 29, 2011.

(30) Foreign Application Priority Data
Aug. 25, 2010 (EP) 10173950.6

(51) Int. Cl. B29C 47/00

(52) U.S. Cl. CPC B29C 47/0064
USPC 156/326

(57) ABSTRACT

Use of two-component polyurethane adhesives as a laminating adhesive for the full-surface adhesive bonding of flexible film substrates to form multilayer films, the adhesive being provided packed into cartridges.

The invention relates to the use of reactive adhesives based on polyurethanes, which are provided as crosslinkable two-component adhesives in cartridges, mixed together and used as laminating adhesives.

Adhesives for bonding flexible films are widely used in industry. One particular field of application is flexible multilayer films, which can then be used for packaging purposes, for example for packaging food, medicines or other items. These adhesives should be applied in a thin layer to allow a cost-effective application. Furthermore, various requirements are made of the composition of the adhesives: they should for example exhibit good and stable adhesion on different substrates. The composition of the adhesive on the substrates to be bonded can be adjusted. Furthermore, for commercial reasons it is necessary for these adhesive bonds to be able to be produced quickly on an industrial scale.

It has therefore proved convenient for many application purposes to bond such films with reactive adhesives. An initial adhesion is first obtained in this way, the lasting bond then being achieved by the chemical reaction of crosslinking. Two-component adhesives, which are mixed together only immediately before application, then applied and bonded within the pot life and which then crosslink, are suitable in particular.

It has frequently proved favorable to use adhesives that have a low viscosity at the application temperature. It is possible to achieve a low film thickness in this way. The viscosity of solvent-containing adhesives can be adjusted to the application equipment. However, the solvents they contain pollute the working atmosphere and the environment, and they require additional technical equipment such as a drying unit.

Two-component adhesives release no volatile substances. However, they do have various disadvantages. Firstly, it is known that a contamination of the application equipment occurs due to the limited pot life. This can lead to external contamination of the apparatus. It is commonly found that the function of the application equipment is also disrupted. Hoses, nozzles and mixing devices can become clogged, for example.

Furthermore, it is essential for two-component adhesives to be mixed in a predefined mixing ratio. This is the only way of ensuring that the anticipated crosslink density of the crosslinked adhesive, as tested under optimum conditions, is achieved. If a component is added in too small a quantity, only poor adhesion is observed in many cases. This leads to a weakening of the substrate bond.

A further disadvantage of such adhesives that have not been crosslinked in the prescribed manner lies in the fact that they generally then also contain low-molecular-weight reactive constituents. During storage these constituents can in some cases migrate through the adhesive layer and through the film. They can then contaminate the item to be packaged, with changes to taste or damage to health possible. For that reason two-component adhesives that have not been crosslinked correctly should be avoided.

Equipment for mixing and preparing two-component adhesives are known. There are industrial installations having various storage tanks, from which the constituents are then mixed together by means of pumps and mixing devices and then applied. This requires a high level of technical complexity, and moreover the operating personnel must not make any mistakes with the volume or weight measuring equipment during mixing.

Furthermore, storage vessels, pumps, hoses or mixing vessels have to be cleaned. In the case of moisture-reactive systems in particular, deposits can otherwise build up on the machine components over time, hampering use and compliance with the specified mixing ratios. By the same token, the long-term storage of partially used transport containers of the individual components is problematic.

The use of two-component adhesives in cartridge form is known in the do-it-yourself sector. Various cartridge shapes are known. A disadvantage of such cartridge applications lies in the fact that in the known applications a relatively large amount of the mixed adhesive is usually produced and applied. This is done for example in the form of adhesive beads, individual dots of adhesive or other patterns. These are not suitable for an application on flat surfaces in a thin layer, such as film substrates. Simply pressing the substrates directly on top of one another or using pressure rollers does not usually lead to a suitable formation of a homogeneous, thin adhesive film.

US 2007/0289996 describes an application device for a two-component polyurethane or epoxy adhesive. Here two adhesive cartridges arranged in parallel are emptied simultaneously by a delivery device, wherein a static mixer having a round tip is described as the discharge device.

DE 19956835 is moreover known. This describes the adhesive bonding of roofing membranes at overlapping edges with a two-component PU adhesive. One substrate here consists of a woven or nonwoven layer into which the adhesive is supposed to penetrate.

EP 2049612 is known. It describes two-component adhesives based on an isocyanate-containing compound and an OH-containing compound. These adhesives are used as laminating adhesives. A more detailed application method or a supply method for this adhesive is not described.

For an application of reactive two-component adhesives, the prior art gives rise to the object of providing the adhesive in a form that reduces contamination of the adhesive supply. Errors in the composition of the adhesive mix should moreover be prevented, such that a good adhesive bond is obtained with complete crosslinking of the adhesive components. Furthermore, these adhesive components should be easy to handle. The adhesive should be suitable for adhesively bonding large, flexible surfaces.

The object is achieved by the use of two-component polyurethane adhesives for the full-surface adhesive bonding of flexible film substrates to form multilayer films, the adhesive being provided packed into cartridges.

The invention moreover relates to the use of a packaging unit (kit) consisting of a two-component adhesive introduced into two separate cartridge units, this kit being used in a device for applying adhesives to film-like substrates. The invention moreover relates to a method for adhesively bonding film-like substrates.

The known flexible films can be used as substrates for producing multilayer films according to the invention. Other flat substrates too, such as paper or board, can additionally be adhesively bonded. They are for example substrates consisting of thermoplastics in film form, for example polyolefins, such as polyethylene (PE) or polypropylene (PP, CPP, OPP), polyvinyl chloride (PVC), polystyrene (PS), polyesters, such as PET, polyamide, natural polymers, such as cellophane or paper. The film materials can also be modified, for example by modifying the polymers with functional groups, or additional components, for example pigments, dyes, can be contained in the film. They can be colored, printed, colorless or transparent films. They can also be adhesively bonded to other substrates such as paper, board or metal foils. Flexible multilayer films are formed in this way, which are adhesively bonded to one another by means of an adhesive layer.

A suitable adhesive according to the invention is a two-component adhesive consisting of two different components that can react with each other to form a crosslinked adhesive film. In particular they are two-component polyurethane adhesives, which crosslink via constituents containing NCO groups and acid H groups. Examples contain as component A the known NCO group-containing prepolymers or polyisocyanates, while the known oligomers or polymers containing OH, NH, SH, COOH groups, which can react with the NCO groups of the other component, can be used as component B. In order to obtain a network, it is convenient for at least two NCO groups and at least two in particular OH groups to be contained in the crosslinking constituents. The additives known per se can moreover be included in the adhesive. These are constituents with which certain properties of the adhesive can be adjusted and influenced.

A polyurethane prepolymer bearing at least two isocyanate groups or a mixture of such PU prepolymers, which can be obtained for example by reacting a polyol component with an at least difunctional isocyanate in stoichiometric excess, is used for example as component A.

PU prepolymers within the meaning of the present invention are reaction products of compounds bearing OH groups or NH groups with an excess of polyisocyanates. They are the polyols known for adhesive applications or corresponding compounds having secondary and/or primary amino groups. OH-containing starting compounds are preferred. Polyols having a molecular weight of up to 20,000 g/mol, in particular from 200 to 10,000 g/mol (number-average molecular weight, M_{N}, as can be determined by GPC), are suitable in particular for synthesizing said prepolymers. They can be polyols based on polyethers, polyesters, polyolefins, polyacrylates, alkylene polyols, for example. In another embodiment such compounds having NH groups are used.

The polyol component can have a low molecular weight, for example from approximately 60 g/mol to 1500 g/mol, but higher-molecular-weight polymers can also be reacted, for example those having a molecular weight from 1500 to 20,000 g/mol. An average of two reactive groups should be present at the polyol, for example diols, but it is also possible to react compounds having several functional groups.

One embodiment preferably uses low-molecular-weight unbranched polyols having a molecular weight of below 1500 g/mol, wherein said polyols should have three or in particular two OH groups. Another embodiment uses OH-containing polymers having a molecular weight of up to 20,000 g/mol. A higher number of OH groups can also be included.

The polyisocyanates known per se having two or more isocyanate groups, such as aliphatic, cycloaliphatic or aromatic isocyanates, can be used as polyisocyanates in the prepolymer synthesis. All known polyisocyanates can be used in principle, in particular the isomers of methylene diisocyanate (MDI) or toluylene diisocyanate (TDI), tetramethylxylylene diisocyanate (TMXDI), 1-isocyanatomethyl-3-isocyanato-1,5,5-trimethylcyclohexane (IPDI), naphthalene-1,5-diisocyanate (NDI), hexane-1,6-diisocyanate (HDI). At least trifunctional isocyanates can also be used, such as are obtained by trimerization or oligomerization of diisocyanates, such as isocyanurates, carbodiimides or biurets. Diisocyanates are preferably used, in particular aromatic diisocyanates.

The reaction control can be influenced by the amount of isocyanates. If a high excess of isocyanates is used, PU prepolymers are formed in which the OH groups have been functionalized in isocyanate groups. Only a slight increase in molecular weight is established in this case. If smaller amounts of isocyanates are used or if the reaction is performed in stages, it is known that the molecular weight of the prepolymers is increased in comparison to the starting compounds. It must be ensured that overall an excess of isocyanate groups is used relative to the complete reaction. The reaction of the polyol compound with the isocyanates can take place in a known manner.

The known PU prepolymers having reactive NCO groups can be used for the invention. Such prepolymers are known to the person skilled in the art and can also be obtained commercially. PU prepolymers that have been produced on the basis of polyester polyols or polyether polyols by reaction with diisocyanates are preferred in particular in the context of this invention. The PU prepolymers used in the context of the present invention generally have a molecular weight from 500 to approximately 30,000 g/mol, preferably up to 15,000 g/mol, in particular from 1000 to 5000 g/mol. Prepolymers are preferred that contain only a small proportion of monomeric, unreacted diisocyanates, e.g. below 1 wt. %.

Another embodiment uses monomeric, oligomeric or polymeric isocyanates as component A. These can be the aforementioned polyisocyanates, for example, or the carbodiimides, isocyanurates or biurets thereof. Mixtures of prepolymers and polyisocyanates are also possible.

In addition to the suitable constituents containing NCO groups, component A can also contain further auxiliary substances and additives. It is important to ensure that only constituents that cannot react with the isocyanate groups are added. This ensures stability in storage.

Component B of a suitable two-component PU adhesive must contain at least one compound having at least two groups that react with isocyanate groups. These can be SH, COOH, NH or OH groups, for example. Polyols are preferred in particular, wherein these can also be mixtures of polyols of differing chemical structure or differing molecular weight.

A large number of polyols are suitable as the polyol component for use in component B. For example they can be those having two up to ten OH groups per molecule. They can be aliphatic compounds or aromatic compounds, and polymers bearing an adequate number of OH groups can also be used. These can be primary or secondary OH groups, provided that they have an adequate reactivity with the isocyanate groups. The molecular weight of such polyols can vary between wide limits, for example from 500 to 10,000 g/mol. The polyols already described above can be included.

Examples of such polyols are low-molecular-weight aliphatic polyols having preferably two to ten OH groups, in particular C₂ to C₃₆ alcohols. Another group of suitable polyols are polyethers, for example. These are the reaction products of alkylene oxides having 2 to 4 C atoms with low-molecular-weight di- or trifunctional alcohols. The polyether polyols should have a molecular weight of in particular 400 to 5000 g/mol. OH-containing poly(meth)acrylates or polyolefins are also suitable.

Polyester polyols are a further suitable group of polyol compounds for use in component B. The polyester polyols that are known for adhesives can be used. They can for example be the reaction products of diols, in particular low-molecular-weight alkylene diols or polyether diols, with dicarboxylic acids. These can be aliphatic or aromatic carboxylic acids or mixtures thereof. Such polyester polyols are known to the person skilled in the art in many forms and are available commercially. These polyester polyols should in particular have a molecular weight of in particular 200 to 3000 g/mol. These also include polymeric lactones or polyacetals, provided that they have at least two functional groups and a corresponding suitable molecular weight.

The suitable polyols according to the invention, which have at least two reactive groups, can be used individually or in a mixture. It is important to ensure that the compounds are miscible with one another and that no phase separation occurs during storage. The viscosity can be influenced by the choice of constituents of component B. If polymeric polyols are used, component B has a higher viscosity. If proportions of low-molecular-weight polyols are used, for example polyalkylene polyols having up to 12 C atoms, the viscosity will become lower. It is convenient according to the invention for component B to be liquid. This can be achieved by the selection of polyols, but in another embodiment it is possible for inert organic solvents to be added.

Two-component laminating adhesives can be produced from the binder components described above. It can be convenient for additional constituents to be contained in these laminating adhesives, such as for example solvents, plasticizers, catalysts, resins, stabilizers, adhesion promoters, pigments or fillers.

In one embodiment the suitable adhesive according to the invention contains at least one tackifying resin. All resins that are compatible and form a largely homogeneous mixture can be used in principle.

Sterically hindered phenols of high molecular weight, polyfunctional phenols, sulfur-containing and phosphorus-containing phenols or amines are suitable as stabilizers or antioxidants for optional use.

It is possible additionally to add silane compounds to the adhesive as adhesion promoters. The known organofunctional silanes, such as (meth)acryloxy-functional, epoxy-functional, amine-functional or unreactive substituted silanes, can be used as adhesion promoters, with methoxy or ethoxy silane groups being suitable in particular.

An adhesive used according to the invention can also contain catalysts as an additive that is optionally additionally present. All known compounds that can catalyze the reaction of OH groups and NCO groups can be used as catalysts. Examples are titanates, tin carboxylates, tin oxides, organoaluminum compounds, tert-amine compounds or salts thereof. Suitable additives are known to the person skilled in the art.

Other embodiments also contain pigments in the adhesive. These are fine-particle pigments, for example platelet-like particles or nanoparticles. Plasticizers can moreover also be included, for example white oils, naphthenic mineral oils, paraffinic hydrocarbon oils, polypropylene, polybutene, polyisoprene oligomers, hydrogenated polyisoprene and/or polybutadiene oligomers, phthalates, adipates, benzoate esters, vegetable or animal oils and derivatives thereof. Plasticizers that are safe in a food regulatory sense are suitable in particular.

According to the invention the adhesives can also contain solvents. These are the conventional solvents, which can evaporate at temperatures up to 120° C. The solvents can be selected from the group of aliphatic hydrocarbons, aromatic hydrocarbons, ketones or esters, in particular of C₂-C₆ carboxylic acids. In another preferred embodiment the two-component adhesive is solvent-free. Through the composition of component A and component B in particular it can be ensured that a mixture of component A and B is obtained that has a low viscosity at temperatures up to 50° C.

A PU adhesive that is used according to the invention consists of a component A containing reactive NCO groups and a component B containing reactive NH or in particular OH groups. In addition components A and B can contain 0 to 30% of additives and auxiliary substances. The additives can in principle be present in both components. It is important to ensure however that additives containing NCO-reactive groups should preferably be included in the OH component. Otherwise the storage stability of the products is reduced.

Components A and components B are stable when stored individually. For application the two components are mixed in such a way that approximately an equal equivalents ratio of OH groups to NCO groups is obtained. The mixing ratio of the adhesives is predefined. It can be between 1:10 and 10:1 (relative to volume), in particular from 1:2 to 2:1.

The two-component PU adhesives that can be used should have a low viscosity at an application temperature of approximately 20 to 80° C. The viscosity of the two-component PU adhesives according to the invention, measured immediately after mixing the constituents, should be between 200 and 10,000 mPas at the application temperature, preferably from 500 to 5000 mPas (at 20 to 60° C., Brookfield viscometer, EN ISO 2555). A higher application temperature may be possible, but it must be borne in mind that the film substrates to be adhesively bonded may be sensitive to heat.

The two-component PU adhesives should be provided in separate storage containers, for example cartridges. Storage, easy application in adhesive application devices and the production of thin adhesive layers on flexible substrates are then possible.

The invention also provides a packaging unit (kit) containing the two-component PU adhesive for use according to the invention. This packaging unit with the adhesive should then be utilized for use as a laminating adhesive for film substrates. A packaging unit according to the invention consists of at least two separate storage containers, in particular in cartridge form, wherein one container contains component A of the adhesive, while the second container contains component B. The packaging unit can moreover have a discharge device which is attached to the storage containers. The configuration and shape of the storage containers can be varied within broad limits. These storage containers can for example be designed as separate cartridges, which are fastened to one another. Another embodiment chooses the storage containers such that a coaxial arrangement of the cartridges within one another is achieved. A further embodiment does not arrange the storage containers as two separate cartridges but rather uses one cartridge, with the different containers being separated from one another by means of a flexible dividing wall.

The shape of the storage containers should preferably be chosen so that if at all possible no pumping, suction or hose devices are necessary. It is preferable for the storage containers to be in the form of a cartridge, wherein pressure can be exerted at the base on a moving base plate by means of a pressure plate for example, so that the contents of a cartridge can emerge through an outlet on the opposite side. A plunger can be provided for each cartridge, but it is also possible for one plunger to empty coaxially arranged cartridges at the same time or for a cartridge having separate storage chambers to be emptied.

The size of the cartridge can vary. It can be between 1 kg and 60 kg. The individual storage containers can be different sizes or they can be similar in size. The size of the storage containers is chosen for example such that the necessary mixing ratio for the adhesive is observed. If for example a 1:1 mix is planned, then it is advantageous to provide cartridges of equal sizes. If different mixing ratios are needed, for example 2:1, it is convenient to provide two cartridges of an appropriate size. It is possible to set the mixing ratio through the shape and size of the outlet. However, the ratio can also be influenced by the speed at which the cartridges are emptied.

An additional constituent of the packaging unit can be a discharge device. This is designed in such a way that the two components from the cartridges can be combined. The discharge device should preferably have a mixing element that is capable of mixing the two components together. This can be a static mixer, for example. It should preferably be positioned at the end of the discharge device. For application of the laminating adhesives the adhesive can be introduced from this discharge device into the application device for the film substrates.

Adapting the two cartridges and the outlet device to the specified mixing ratio for the individual adhesive ensures that a uniform consumption is obtained. Both storage containers should be emptied at roughly the same time, after which they can be replaced and disposed of. As the storage containers are fitted with a discharge device at their outlet, downstream of which there is preferably a static mixer, there is no risk of a premature mixing of the adhesive components in the event of a stoppage of the conveyor equipment. The kit should preferably be designed in such a way that if the adhesive supply is not used within the designated pot life of the two-component PU adhesive, the discharge unit and mixing element can easily be exchanged for a new, uncontaminated unit.

The invention moreover provides a method for adhesively bonding two film-like substrates. Here an adhesive can be prepared as required from the packaging unit according to the invention. It is mixed in the specified mixing ratio, using a static mixer for example. From the outlet device of the mixing device the adhesive is introduced into the laminating adhesive application device in the form of a strand for example. The application device produces a flat adhesive layer from the adhesive strand. The adhesive can be applied to the films using known devices. These are known to the person skilled in the art and can comprise knife application, print application, slot nozzle application or roller application. Roller application, which produces a thin and uniform adhesive layer using several rollers for example, is suitable in particular. This layer is then transferred flat onto the film. The film is then joined together with a second film, either another plastic film, multilayer film, a metallized film or a paper or board substrate, and adhesively bonded under pressure.

It can be convenient to heat the cartridges or these rollers. In this way a low viscosity of the two-component PU adhesive can be established under application conditions. Conventional application temperatures for two-component PU adhesives for use according to the invention are between 20 and 80° C., in particular up to 60° C.

According to the method according to the invention a suitable adhesive is applied as a layer to a substrate. The adhesive should be applied in a film thickness from 1 g/m² to 100 g/m², preferably from 1 to 30 g/m², in particular less than 20 g/m².

Through the use according to the invention of the adhesive components provided in cartridges an advantageous application of such laminating adhesives is possible. By means of the predefined size and shape of the two cartridges and optionally together with the discharge device it is possible to ensure that no mixing errors occur in the two-component PU adhesive. It is moreover possible to use simple discharge devices from the storage containers. The mode of operation according to the invention prevents contamination of the conveying equipment, for example pumps or pipes. It is possible to switch to different adhesives having a different application profile. Through the provision of static mixing elements, which in particular can be designed as disposable elements, clogging of the conveying equipment by adhesive that has already been mixed but not applied is prevented even if production is interrupted.

The use of two-component PU adhesives known per se in the form of cartridges, in particular in the form of a coordinated kit of the adhesive components, allows the coating of film substrates to be simplified substantially.

What is claimed is:

1. A method of a multilayer film, comprising:
providing a first component of a two component polyurethane adhesive, wherein the first component is disposed within a first cartridge;
providing a second component of the two component polyurethane adhesive, wherein the second component is disposed within a second cartridge;
dispensing a first amount of the first component and a second amount of the second component to a mixing device to mix the components and form a mixed two component polyurethane adhesive;
applying mixed two component polyurethane adhesive to a substrate of a first flexible film;
disposing a second flexible film over the applied two component polyurethane adhesive; and
bonding the first flexible film to the second flexible film to form the multilayer film.

2. The method according to claim 1, wherein the mixed two-component polyurethene adhesive has a viscosity at 20 to 60° C. of between 200 and 10,000 mPas (EN ISO 2555).

3. The method according to claim 1, wherein the mixed two-component PU adhesive is applied in an amount from 1 to 100 g/m².

4. The method according to claim 1, wherein the mixing ratio of the components of the two component polyurethene adhesive is between 1:10 and 10:1.

5. The method according to claim 4, wherein the mixing ratio is governed by the configuration of a discharge device, by the configuration of the cartridges and/or by the discharge rate of the cartridges.

6. The method according to claim 1, wherein the mixed two-component polyurethene adhesive is free from solvents.

7. The method according to claim 1, wherein the first and second flexible films are independently selected from thermoplastic films, paper, board and metal foil.

8. The method according to claim 1, wherein the components of the adhesive are provided as a packaging unit in two separate containers in cartridge form, and the components can be mixed together by means of a discharge device in a predefined mixing ratio as a laminating adhesive for the full-surface adhesive bonding of multilayer films.

9. The method according to claim 8, wherein the cartridges are made from metal, plastic or coated board.

10. The method according to claim 8, wherein the packaging unit is a disposable container.

11. A method for adhesively bonding film substrates, wherein a two-component PU adhesive is provided in cartridge form and is introduced by means of a discharge device having a mixing element into an adhesive application device for film substrates.

12. The method for adhesively bonding film substrates according to claim 11, wherein the adhesive is applied to the entire surface of the substrate using a roller.

13. The method for adhesively bonding film substrates according to claim 11, wherein the mixing element is interchangeably mounted.

14. The method for adhesively bonding film substrates according to claim 9, wherein the adhesive is applied at a temperature of between 20 and 80° C.
